(19) United States
(12) Patent Application Publication
(10) Pub. No.: US 2025/0238065 A1
(43) Pub. Date: Jul. 24, 2025

(54) METHOD FOR ADJUSTING POWER CONSUMPTION, ELECTRONIC DEVICE, AND NON-TRANSISTORY COMPUTER-READABLE STORAGE MEDIUM

(71) Applicant: GUANGDONG OPPO MOBILE TELECOMMUNICATIONS CORP., LTD., Dongguan, Guangdong (CN)

(72) Inventor: Yuan YU, Dongguan, Guangdong (CN)

(73) Assignee: GUANGDONG OPPO MOBILE TELECOMMUNICATIONS CORP., LTD., Dongguan, Guangdong (CN)

(21) Appl. No.: 18/874,548

(22) PCT Filed: Nov. 1, 2021
(86) PCT No.: PCT/CN2021/127956

§ 371 Date: Dec. 12, 2024

(30) Foreign Application Priority Data
Dec. 19, 2020 (CN) 202011509394.5

(51) Int. Cl. G06F 1/3206; G06F 1/16; G06F 1/3293

(52) U.S. Cl. CPC G06F 1/3206; G06F 1/163; G06F 1/3293

(57) ABSTRACT

A method for adjusting power consumption, an electronic device, and a non-transitory computer-readable storage medium are provided. The electronic device is capable of simultaneously running a first operating system and a second operating system. The method includes: obtaining a current state of a user; and in a case where the current state of the user meets a system-state switching condition, controlling the second operating system to enter a target operating state. Power consumption of the second operating system in the target operating state is lower than power consumption of the second operating system in the first operating state. The second operating system can enter a target operating state according to the current state of the user.

### CROSS-REFERENCE TO RELATED APPLICATIONS

This application is a 35 U.S.C. § 371 National Phase filing of International Patent Application No. PCT/CN2021/127956, filed on Nov. 1, 2021, which claims priority to China Patent Applicant No.202011509394.5, filed on Dec. 19, 2020, the entire contents of which are incorporated herein by reference.

### TECHNICAL FIELD

Embodiments of the present disclosure relate to the field of computer technologies, in particular, to a method for adjusting power consumption, an electronic device, and a non-transitory computer-readable storage medium.

### BACKGROUND

With the continuous development of computer technology, electronic devices are becoming increasingly powerful. However, as functionalities of the electronic devices grow, power consumption of the electronic devices also increases, which in turn shortens the battery life of the electronic devices. Extending the battery life of the electronic devices has therefore become an urgent issue to address.

### SUMMARY

Some embodiments of the present disclosure provide a method for adjusting power consumption, an electronic device, and a non-transitory computer-readable storage medium.

Some embodiments of the present disclosure provide a method for adjusting power consumption. The method is performed by an electronic device. The electronic device is capable of simultaneously running a first operating system and a second operating system. The method may include the following:
obtaining a current state of a user; and
controlling the second operating system to enter a target operating state, in a case where the current state of the user meets a system-state switching condition, wherein power consumption of the second operating system in the target operating state is lower than power consumption of the second operating system in a first operating state.

Some embodiments of the present disclosure further provide an electronic device. The electronic device may be capable of simultaneously running a first operating system and a second operating system. The electronic device may include a processor and a memory. The memory may store a computer program which, when executed by the processor, causes the processor to perform the aforementioned method for adjusting power consumption.

Some embodiments of the present disclosure further provide a non-transitory computer-readable storage medium. The non-transitory computer-readable storage medium may store a computer program which, when executed by a processor, cause the processor to perform the aforementioned method for adjusting power consumption.

### BRIEF DESCRIPTION OF THE DRAWINGS

To illustrate the technical solutions in some embodiments of the present disclosure or the related art, a brief introduction to the drawings used in some embodiments of the present disclosure or the related art is provided below. It is evident that the drawings described below are only some of the embodiments of the present disclosure in some embodiments of the present disclosure. For those skilled in the art, other drawings may be derived based on the following drawings without creative work.

FIG. 1 is a schematic view of an application scenario of a method for adjusting power consumption in some embodiments of the present disclosure.

FIG. 2 is a flowchart of a method for adjusting power consumption in some embodiments of the present disclosure.

FIG. 3 is a flowchart of a method for adjusting power consumption in some embodiments of the present disclosure.

FIG. 4 is a schematic view of modules installed under a first operating system and a second operating system in some embodiments of the present disclosure.

FIG. 5 is a flowchart of a method for adjusting power consumption in some embodiments of the present disclosure.

FIG. 6 is a flowchart of the obtaining a current state of a user shown in FIG. 2.

FIG. 7 is a flowchart of a method for adjusting power consumption in some embodiments of the present disclosure.

FIG. 8 is a structural block diagram of an apparatus for adjusting power consumption in some embodiments of the present disclosure.

FIG. 9 is a structural block diagram of an apparatus for adjusting power consumption in some embodiments of the present disclosure.

FIG. 10 is a block diagram illustrating an internal structure of an electronic device in some embodiments of the present disclosure.

### DETAILED DESCRIPTION

To make the purpose, the technical solution, and the advantages of the present disclosure clearer, the following provides a more detailed description of the present disclosure with reference to the accompanying drawings and embodiments. It should be understood that the embodiments described herein are merely for illustration, not for limitation, the present disclosure.

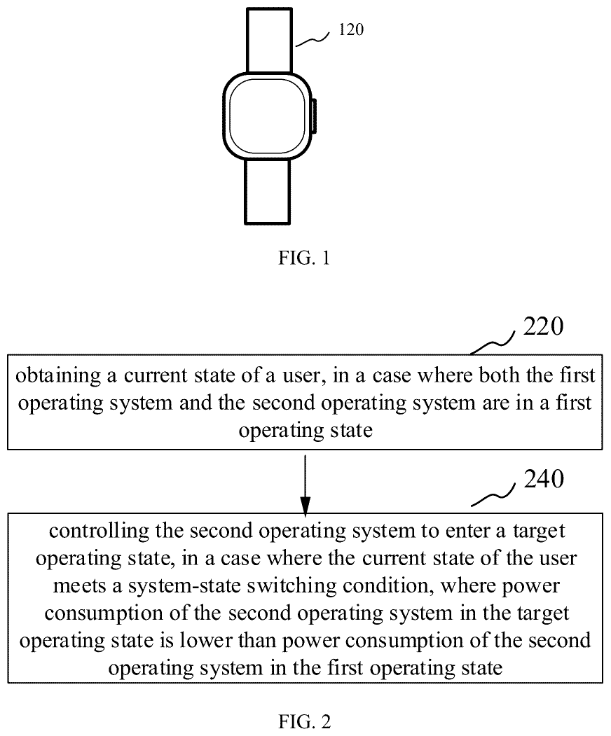

FIG. 1 is a schematic view of an application scenario of a method for adjusting power consumption in some embodiments of the present disclosure. As shown in FIG. 1, the application scenario includes an electronic device 120. The electronic device 120 is an electronic device with a dual system. The dual system includes a first operating system and a second operating system. Through a method for adjusting power consumption described in some embodiments of the present disclosure, the electronic device 120 is configured to obtain a current state of a user in a case where both the first operating system and the second operating system are in a first operating state. In a case where the current state of the user meets a system-state switching condition, the second operating system enters a target operating state. Power consumption of the second operating system in the target operating state is lower than power consumption of the second operating system in the first operating state. In some embodiments, the electronic device 120 may include any terminal device, such as a mobile phone, a tablet, a personal digital assistant (PDA), a wearable device (a smart watch), a smart home device, etc. The smart watch refers to a watch that is able to process information and meets a basic functional requirement of a watch.

FIG. 2 is a flowchart of a method for adjusting power consumption in some embodiments of the present disclosure. The method for adjusting power consumption in some embodiments is described as performed by the electronic device 120 shown in FIG. 1. The electronic device 120 is capable of simultaneously running the first operating system and the second operating system. As shown in FIG. 2, the method for adjusting power consumption may include an operation 220 and an operation 240.

In the operation 220, a current state of a user may be obtained, in a case where both the first operating system and the second operating system are in a first operating state.

A battery life is increasingly becoming an important performance indicator of an electronic device. To address a battery life problem, more and more electronic devices are using a dual system approach to reduce power consumption. Typically, the electronic device 120 may run two systems in the dual system simultaneously or only one of the two systems with the capability of switching between the two systems. One of the two systems, e.g., a real-time operating system (RTOS), has relatively low power consumption during operation and is configured to support a fundamental function of the electronic device 120, such as a time display function, an alarm scheduling function, a physiological data monitoring function, and a call notification function, etc. The other one of the two systems, e.g., an Android system, has relatively high power consumption during operation and is configured to support a complex function of the electronic device 120, such as a video and voice calling function, a gaming function, a multimedia playback function, a WIFI function, a power management function, etc. In some embodiments of the present disclosure, a system with lower power consumption is referred to as the first operating system and a system with higher power consumption is referred to as the second operating system.

The first operating state may be referred to as at least one of a normal operating state and a high-power operating state. The first operating system in the first operating state has relatively low power consumption and is able to support the fundamental function of the electronic device 120. The second operating system in the first operating state has relatively high power consumption but is able to support the complex function of the electronic device 120. In a case where the second operating system is in any operating state other than the first operating state, the second operating system has relatively low power consumption but is generally no longer able to support the complex function of the electronic device 120. Therefore, in a case where the user only requires the electronic device 120 to support the fundamental function, only the first operating system may be controlled to operate in the first operating state and the second operating system may not be further controlled to operate in the first operating state.

Since the second operating system has relatively high power consumption in the first operating state, the current state of the user may be obtained in real time in a case where both the first operating system and the second operating system are in the first operating state. Based on the current state of the user, whether the current state of the user meets the system-state switching condition may be determined. In a case where the current state of the user meets the system-state switching condition, the second operating system may be switched to another operating state, thereby reducing the power consumption of the electronic device 120. The current state of the user may include a sleep state, a do-not-disturb state, an awake state, etc., which is not limited herein.

In the operation 240, the second operating system is enabled to enter a target operating state, in a case where the current state of the user meets a system-state switching condition, where power consumption of the second operating system in the target operating state is lower than power consumption of the second operating system in the first operating state.

The system-state switching condition is that the current state of the user is a preset state. The preset state, for example, may include the sleep state, the do-not-disturb state, etc. Since the user in the sleep state or the do-not-disturb state has a lower requirement for the function supported by the electronic device 120, the electronic device 120 only needs to support the fundamental function to meet the user needs.

In some embodiments, in a case where both the first operating system and the second operating system are in the first operating state, the current state of the user is obtained. When the current state of the user meets the system-state switching condition, the second operating system is controlled or enabled to switch from the first operating state to another operating state. In some embodiments, the second operating system is controlled or enabled to switch from the first operating state to the target operating state that corresponds to or matches with the current state of the user.

The target operating state that corresponds to or matches with the current state of the user means an operating state of the second operating system is associated with or linked to the current state of the user, such that the operating state of the second operating system matches with the current state of the user. In a case where the current state of the user requires the electronic device 120 to support the complex function, the second operating system has to be in the first operating state to meet the user needs. However, in a case where the current state of the user only requires the electronic device 120 to support the fundamental function, the second operating system may not be in the first operating state, thereby reducing the power consumption. In this case, the second operating system needs to switch from the first operating state to the target operating state. The power consumption of the second operating system in the target operating state is lower than the power consumption of the second operating system in the first operating state.

A requirement of the user for the electronic device 120 varies with the current state of the user. In some cases, both the first operating system and the second operating system on the electronic device 120 are initially in the first operating state (i.e., at least one of the normal operating state and the high-power operating state), which matches with the current state of the user, i.e., the user requires the electronic device to support the complex function. In a case where the user enters the sleep state, the current state of the user meets the system-state switching condition. The user in the sleep state apparently no longer requires the electronic device 120 to support the complex function but only requires the electronic device 120 to support the fundamental function that may be provided by the first operating system alone. Thus, when the user currently is in the sleep state, the second operating system is controlled or enabled to enter the target operating state that corresponds to or matches with the sleep state of the user, i.e., an operating state other than the first operating state. Obviously, the power consumption of the second operating system in the target operating state is lower than the power consumption of the second operating system in the first operating state.

In some embodiments of the present disclosure, the electronic device 120 is capable of simultaneously running the first operating system and the second operating system. The method for adjusting power consumption may include: monitoring the current state of the user, in a case where both the first operating system and the second operating system are in the first operating state; and controlling or enabling the second operating system to enter the target operating state, in a case where the current state of the user meets the system-state switching condition. The power consumption of the second operating system in the target operating state is lower than the power consumption of the second operating system in the first operating state. In this way, the second operating system is adapted to enter the target operating state based on the current state of the user, which allows an appropriate target operating state to be configured for the second operating system based on the current state of the user, thereby reducing the power consumption of the electronic device 120 while meeting the user needs.

In some embodiments, the target operating state includes a standby state of the second operating system or a shutdown state of the second operating system.

In some embodiments, when the current state of the user meets the system-state switching condition, the second operating system enters the target operating state. The system-state switching condition is that the current state of the user is the preset state. The preset state, for example, may include the sleep state or the do-not-disturb state. In a case where the current state of the user is the sleep state or the do-not-disturb state, the user only requires the electronic device 120 to support the fundamental function that may be provided by the first operating system alone. Therefore, the second operating system may be directly controlled or enabled or operated to enter the standby state or the shutdown state.

The second operating system in the standby state means that all applications and modules running on the second operating system are in the standby state. That is, data of the second operating system is stored in a memory, a low power supply is provided to the memory, all components under the second operating system, except the memory, are powered off, and the applications and the modules are paused from running. Since the memory is not powered off, the second operating system may directly read the data stored in the memory when the second operating system is awakened next time.

The second operating system in the shutdown state means that all the applications and the modules running on the second operating system are in the shutdown state. That is, all devices in the second operating system are powered off and the applications and the modules are shut down. Since the memory is powered off, the second operating system has to be re-initialized in order to run properly when the second operating system is awakened next time.

In additional, since the second operating system runs on a central processing unit (CPU), the CPU may be in different states depending on the operating state of the second operating system. For example, a frequency of the CPU in a case where the second operating system is in the standby state may be lower than a frequency of the CPU in a case where the second operating system is in the normal operating state. A frequency of the CPU in a case where the second operating system is in the shutdown state may be lower than the frequency of the CPU in a case where the second operating system is in the standby state. An exact frequency value of the CPU is not limited herein.

In some embodiments of the present disclosure, when the current state of the user meets the system-state switching condition, the second operating system enters the target operating state. In some embodiments, in a case where the current state of the user is the sleep state or the do-not-disturb state, the user only requires the electronic device 120 to support the fundamental function that may be provided by the first operating system alone. Thus, the second operating system may be directly controlled or enabled to enter the standby state or the shutdown state, which reduces the power consumption to the maximum extent while still allows the user to use the fundamental function in a case where the user is in the sleep state or the do-not-disturb state.

In some embodiments, the controlling or enabling the second operating system to enter the target operating state in a case where the current state of the user meets the system-state switching condition, may include: controlling or enabling the second operating system to enter the target operating state, in a case where the current state of the user is the sleep state.

The system-state switching condition is that the current state of the user is the preset state. The preset state, for example, may include the sleep state or the do-not-disturb state. In some embodiments, in a case where the current state of the user is the sleep state, the current state of the user meets the system-state switching condition and the second operating system is thus controlled or enabled to enter the standby state or the shutdown state. In a case where the current state of the user is the do-not-disturb state, the current state of the user meets the system-state switching condition and the second operating system is thus controlled to enter the standby state or the shutdown state.

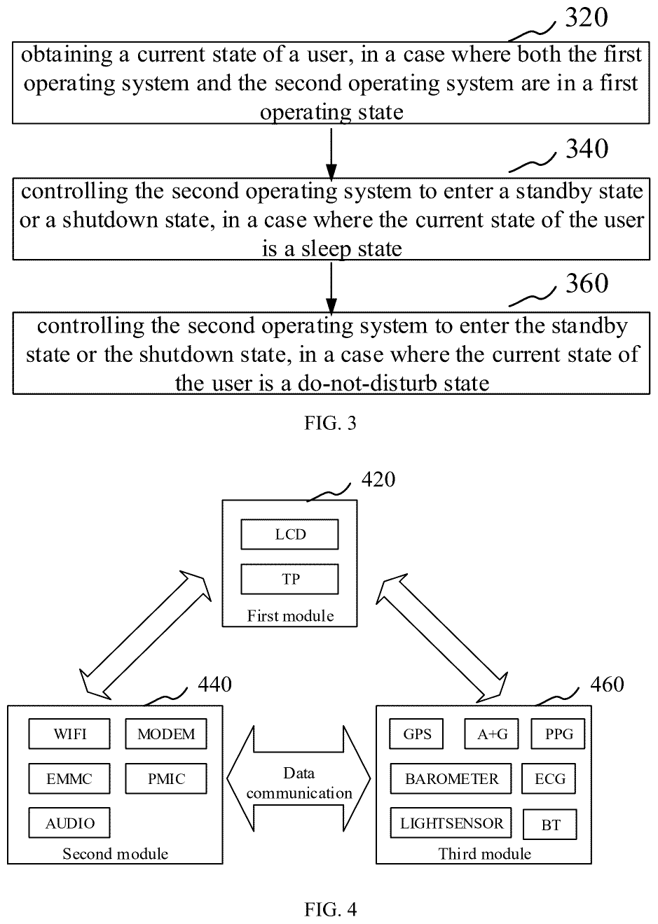

As shown in FIG. 3, a method for adjusting power consumption is provided. The method may include the following operations.

In an operation 320, a current state of a user may be detected, in a case where both a first operating system and a second operating system are in a first operating state.

In an operation 340, the second operating system may be controlled or enabled to enter a standby state or a shutdown state, in a case where the current state of the user is a sleep state.

In an operation 360, the second operating system may be controlled or enabled to enter the standby state or the shutdown state, in a case where the current state of the user is a do-not-disturb state.

In some embodiments of the present disclosure, when the current state of the user meets the system-state switching condition, for example, the current state of the user is the sleep state, the second operating system is controlled or enabled to enter the standby state or the shutdown state. When the current state of the user is the do-not-disturb state, the current state of the user is determined to meet the system-state switching condition and the second operating system may be controlled or enabled to enter the standby state or the shutdown state. In this way, the second operating system is controlled to enter the operating state that corresponds to or matches with the current state of the user based on the current state of the user, which reduces the power consumption to the maximum extent while still allows the user to use the fundamental function.

In some embodiments, the operation of controlling or enabling the second operating system to enter the target operating state may include at least one of the following operations: transferring a control authority over a first module from the second operating system to the first operating system, where the first module is a common callable module shared by the first operating system and the second operating system; or controlling or enabling a second module operating under the second operating system to enter the target operating state.

FIG. 4 is a schematic view of modules mounted under a first operating system and a second operating system in an electronic device 120 in some embodiments of the present disclosure. A common callable module, i.e., a first module 420, may be called by both the first operating system and the second operating system. The first module 420 may include a liquid crystal display (LCD) module, a touch panel (TP) module, etc., which is not limited herein. The common callable module is configured to ensure the user to normally use the common callable module, such as the LCD module, the TP module, etc., under any one of the first operating system and the second operating system.

A second module 440 is a module that may be called only by the second operating system. The second module 440 may include a WIFI module, a modem, a memory, i.e., an embedded MultiMediaCard (EMMC), a power management IC (PMIC), an audio module, etc., which is not limited herein. The second operating system may support the complex function of the electronic device 120, such as the video and voice calling function, the gaming function, the multimedia playback function, etc., through the second module 440.

A third module 460 is a module that may be called only by the first operating system. The third module 460 may include a global positioning system (GPS) module, an accelerometer and gyroscope (A+G) sensor module, a PhotoPlethysmoGraphy (PPG) sensor, a barometer, an electrocardiogram (ECG), a light sensor, and a Bluetooth (BT) module, etc., which is not limited herein. The first operating system may support the fundamental function of the electronic device 120, such as the time display function, the alarm scheduling function, the physiological data monitoring function, the call notification function, etc., through the third module 460.

When the current state of the user meets the system-state switching condition, the second operating system is controlled or enabled to enter the target operating state. In some embodiments, the operation of controlling or enabling the second operating system to enter the target operating state may include: transferring the control authority over the first module from the second operating system to the first operating system, where the first module is the common callable module shared by the first operating system and the second operating system; and controlling or enabling the second module 440 operating under the second operating system to enter the target operating state. That is to say, when the current state of the user meets the system-state switching condition, the control authority over the first module is transferred from the second operating system to the first operating system. In this case, the second operating system no longer has the control authority to call the common callable module, while the first operating system still has the control authority to call the common callable module. In addition, the second operating system further controls or enables the second module 440 to enter the standby state or the shutdown state.

In some embodiments, the operation of controlling or enabling the second operating system to enter the target operating state may include: transferring the control authority over the first module from the second operating system to the first operating system, where the first module is the common callable module shared by the first operating system and the second operating system; or controlling or enabling the second module 440 operating under the second operating system to enter the target operating state. In some embodiments, two cases are provided. In the first case, the control authority over the first module is transferred from the second operating system to the first operating system and the second operating system no longer controls the second module 440. In the second case, the second module 440 operating under the second operating system is controlled to enter the standby state or the shutdown state and the second operating system no longer controls the first module.

In some embodiments of the present disclosure, the modules in the electronic device 120 are divided into the following: the common callable module that may be called by both the first operating system and the second operating system, the module that may be called only by the first operating system, and the module that may be called only by the second operating system. In this way, during the operation of controlling or enabling the second operating system to enter the target operating state, the common callable module or the module that may be called only by the second operating system may be precisely controlled, thereby ensuring the second operating system to be accurately controlled to enter the target operating state.

In some embodiments, the transferring the control authority over the first module from the second operating system to the first operating system, may include: sending a control-authority transfer instruction from the first operating system to the second operating system, where the control-authority transfer instruction is configured to indicate the second operating system to transfer the control authority over the first module to the first operating system.

The common callable module, i.e., the first module, may be called by both the first operating system and the second operating system. The first module may include the LCD module, the TP module, etc., which is not limited herein. The operation of controlling or enabling the second operating system to enter the target operating state may include: transferring the control authority over the first module from the second operating system to the first operating system. In some embodiments, the control-authority transfer instruction is sent from the first operating system to the second operating system and, when the second operating system receives the control-authority transfer instruction, the second operating system transfers the control authority over the first module to the first operating system. For example, the second operating system transfers the control authority over the LCD module, the TP module, etc., to the first operating system.

In some embodiments of the present disclosure, the control-authority transfer instruction is sent from the first operating system to the second operating system and, when the second operating system receives the control-authority transfer instruction, the second operating system transfers the control authority over the first module to the first operating system. In other words, through transferring the control authority over the first module to the first operating system, the first module may continue to be controlled by the first module even after the second operating system enters the standby state or the shutdown state, thereby ensuring the user to be still able to call the first module under the first operating system.

In some embodiments, the controlling or enabling the second module 440 operating under the second operating system to enter the target operating state, may include: sending a control instruction from the first operating system to the second operating system, where the control instruction is configured to control or enable the second module 440 operating under the second operating system to enter the target operating state.

The second module 440 is the module that may be called only by the second operating system. The second module 440 may include the WIFI module, the modem, the memory, i.e., the EMMC, the PMIC, the audio module, etc., which is not limited herein.

The controlling or enabling the second module 440 operating under the second operating system to enter the target operating state, may include: sending the control instruction from the first operating system to the second operating system; and in a case where the second operating system receives the control instruction, controlling, by the second operating system, the second module 440 operating under the second operating system to enter the target operating state based on the control instruction. For example, the control instruction is configured to control or enable the second module 440 operating under the second operating system to enter the standby state or the shutdown state.

In some embodiments of the present disclosure, the controlling or enabling the second module 440 operating under the second operating system to enter the target operating state, may include: sending the control instruction from the first operating system to the second operating system; and in a case where the second operating system receives the control instruction, controlling or enabling, by the second operating system, the second module 440 operating under the second operating system to enter the target operating state based on the control instruction. Since the first operating system operates at lower power consumption, the first operating system controls or enables the second module 440 operating under the second operating system to enter the standby state or the shutdown state, which enables only the first operating system of the electronic device 120 to remain in the first operating state, thereby reducing the power consumption of the electronic device 120 while still allowing the user to normally use the electronic device 120 with the first operating system.

In some embodiments, a method for adjusting power consumption is provided. The method may further include the following operations: controlling the second operating system to revert to the first operating state from the target operating state, in a case where the current state of the user is a non-sleep state.

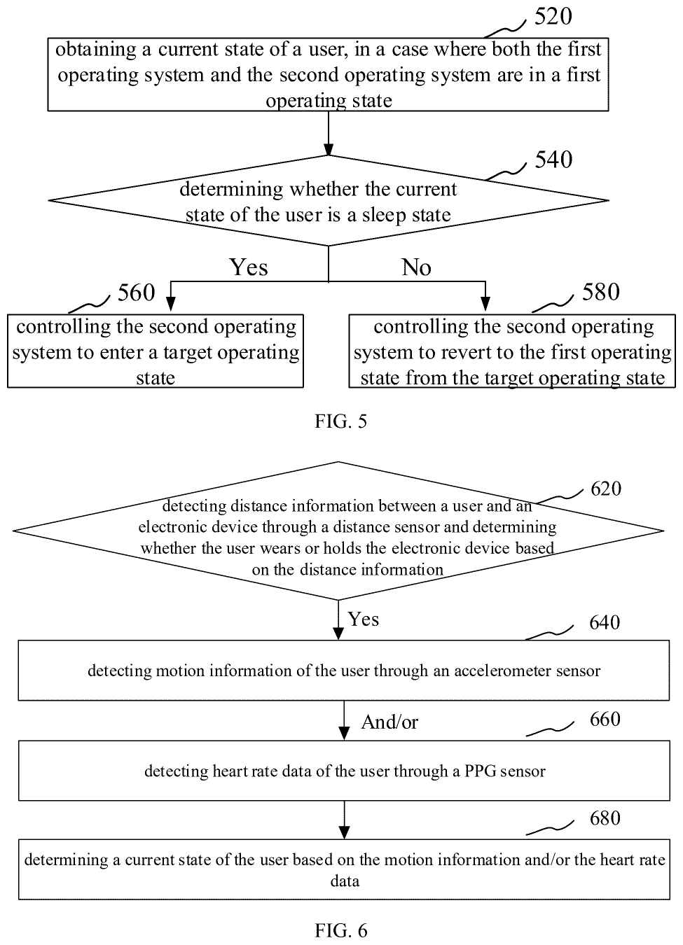

As shown in FIG. 5, a method for adjusting power consumption is provided. The method includes the following operations.

In an operation 520, a current state of a user is detected, in a case where both a first operating system and a second operating system are in a first operating state.

In an operation 540, whether the current state of the user is a sleep state is determined.

In an operation 560, the second operating system is enabled to enter a target operating state, in a case where the current state of the user is the sleep state.

In an operation 580, the second operating system is controlled or enabled to revert to the first operating state from the target operating state, in a case where the current state of the user enters a non-sleep state from the sleep state.

The first operating state may be referred to as at least one of the normal operating state and the high-power operating state. The second operating system in the first operating state has relatively high power consumption and is able to support the complex function of the electronic device 120. However, in a case where the second operating system is in any operating state other than the first operating state, the second operating system has relatively low power consumption and is generally no longer able to support the complex function of the electronic device 120.

In some embodiments, the current state of the user may be obtained, in a case where both the first operating system and the second operating system are in the first operating state. Based on the current state of the user, whether the current state of the user meets the system-state switching condition may be determined. When the current state of the user meets the system-state switching condition, the second operating system may be switched to another operating state, thereby reducing the power consumption of the electronic device 120. The system-state switching condition is that the current state of the user is the preset state. The preset state, for example, may include the sleep state or the do-not-disturb state.

When the current state of the user is the sleep state, the current state of the user meets the system-state switching condition and the second operating system is thus controlled or enabled to enter the target operating state. That is, the second operating system is controlled or enabled to enter the standby state or the shutdown state. Since the user in the sleep state has a lower requirement for the function supported by the electronic device 120, the electronic device 120 only needs to support the fundamental function to meet the user needs. In this way, because the fundamental function may be supported by the first operating system alone, the second operating system may be controlled or enabled to enter the standby state or the shutdown state.

The current state of the user then continues to be detected. In a case where the current state of the user enters the non-sleep state from the sleep state, the second operating system is controlled or enabled to revert to the first operating state from the target operating state. Since the user enters in the non-sleep state, the user has a higher requirement for the function supported by the electronic device 120, i.e., requiring not only the fundamental function but also the complex function. Since the first operating system is configured to support only the fundamental function, the second operating system needs to be controlled to revert to the first operating state to support the complex function. In some embodiments, the second operating system restores the control authority over the first module and the second module 440 operating under the second operating system is controlled to revert to the first operating state.

In some embodiments of the present disclosure, the current state of the user may be obtained in real time in a case where both the first operating system and the second operating system are in the first operating state. When the current state of the user is the sleep state, the second operating system enters the target operating state. The current state of the user then continues to be detected. In a case where the current state of the user is the non-sleep state, the second operating system reverts to the first operating state from the target operating state. That is to say, when the current state of the user changes, the second operating system may be switched to another operating state correspondingly. In this way, the second operating system is controlled to match with the current state of the user based on the current state of the user, thereby reducing the power consumption of the electronic device 120 while meeting the user needs.

In some embodiments, as shown in FIG. 6, the operation of obtaining the current state of the user may include the following operation: determining the current state of the user based on at least one of motion information or at least one of heart rate data, in a case where the user wears or holds the electronic device 120. The operation may further include the following operations.

In an operation 620, distance information between a user and an electronic device 120 may be detected through a distance sensor and whether the user wears or holds the electronic device 120 may be determined based on the distance information.

The electronic device 120 is equipped with the distance sensor, the accelerometer sensor, and the PPG sensor. The distance sensor, also known as a proximity detector, is configured to calculate a distance through measuring time. A working principle of the distance sensor is that, the distance sensor emits light pulses and measures time taken for the light pulses to reflect from an object, i.e., calculating the distance between the distance sensor and the object through measuring the reflection time. During a process of monitoring the current state of the user, the distance information between the user and the electronic device 120 on which the distance sensor is installed is first detected through the distance sensor, and then whether the user is wearing or holding the electronic device 120 may be determined based on the distance information. For example, a preset distance threshold may be set. In a case where the distance information between the user and the electronic device 120 detected through the distance sensor is less than the preset distance threshold (e.g., 1 cm), the user is determined to currently wear or hold the electronic device 120. In a case where the distance information between the user and the electronic device 120 detected through the distance sensor is greater than or equal to the preset distance threshold (e.g., 1 cm), the user is determined to currently neither wear nor hold the electronic device 120. The preset distance threshold may be determined based on an empirical value or may be set to other values in practice, which is not limited to the 1 cm mentioned above.

In an operation 640, motion information of the user may be detected through the accelerometer sensor, in a case where the user wears or holds the electronic device; and/or in an operation 660, heart rate data of the user may be detected through the PPG sensor, in a case where the user wears or holds the electronic device.

In an operation 680, the current state of the user may be determined based on at least one of the motion information or at least one of the heart rate data.

In a case where the distance information between the user and the electronic device 120 detected through the distance sensor is less than the preset distance threshold, the user is determined to currently wear or hold the electronic device 120. The motion information of the user is then detected through the accelerometer sensor; in some embodiments, the motion information of the user is detected by means of the accelerometer sensor monitoring accelerations of the electronic device 120 in three axes in real time, and determining the motion information of the user based on the accelerations of the electronic device 120 in three axes over a preset duration. For example, when an average value of the accelerations of the electronic device 120 in three axes over the preset duration is greater than a preset acceleration threshold, the user is determined to be in an active state. When the average value of the accelerations of the electronic device 120 in three axes over the preset duration is less than or equal to the preset acceleration threshold, the user is determined to be in a non-active state.

In a case where the distance information between the user and the electronic device 120 detected through the distance sensor is less than the preset distance threshold, the user is determined to currently wear or hold the electronic device 120. The heart rate data of the user is then detected through the PPG sensor. In some embodiments, the heart rate data is detected by the PPG sensor by using the PhotoPlethysmoGraphy in a way that the PPG sensor first emits light with a specific color and wavelength into a particular part of user skin through a light-emitting diode of the PPG sensor and then detects a pulse signal through receiving corresponding reflection light or incident light.

At least one of the motion information or at least one of the heart rate data are input into a sleep detection algorithm to determine the current state of the user. In this way, three cases may be provided. In the first case, when the distance information between the user and the electronic device 120 detected through the distance sensor is less than the preset distance threshold, which indicates that the user currently wears or holds the electronic device 120, the accelerometer sensor directly detects the motion information of the user. In this case, the current state of the user may be finally determined based on the motion information. For instance, in a case where the user is determined to be in the active state through the accelerometer sensor, the heart rate data may not continue to be further detected and the user is determined to be currently in the non-sleep state, thereby avoiding additional power consumption from an unnecessary heart rate monitoring.

In the second case, when the distance information between the user and the electronic device 120 detected through the distance sensor is less than the preset distance threshold, which indicates that the user currently wears or holds the electronic device 120, the PPG sensor directly detects the heart rate data of the user. In this case, the current state of the user may be finally determined based on the heart rate data. For example, heart rate data that corresponds to the sleep state may be pre-determined to be in a range of 60-80 times/min. In a case where the heart rate data of the user detected through the PPG sensor falls within the range of 60-80 times/min, the user is determined to be currently in the sleep state. In a case where the heart rate data of the user detected through the PPG sensor exceeds 80 times/min, the user is determined to be currently in the non-sleep state. Obviously, the heart rate values mentioned above are merely illustrative and may be adjusted in practice according to a physiological condition of the user, in order to comply with individual differences. In a case where the heart rate data of the user detected through the PPG sensor falls within the heart rate range that corresponds to the sleep state, the motion information may not continue to be further detected and the user is determined to be currently in the non-sleep state.

In the third case, when the distance information between the user and the electronic device 120 detected through the distance sensor is less than the preset distance threshold, which indicates that the user currently wears or holds the electronic device 120, the motion information of the user is first detected through the accelerometer sensor, and the heart rate data of the user is then detected through the PPG sensor. In this case, the current state of the user is finally determined based on both the motion information of the user and the heart rate data of the user. Through determining the current state of the user from two dimensions, the obtained current state of the user may be more accurate. For example, in a case where the user is determined to be currently in the non-active state through the accelerometer sensor and the heart rate data of the user over the preset duration falls within the range of 60-80 times/min, the user is determined to be in the sleep state from the two dimensions.

In some embodiments of the present disclosure, when the distance information between the user and the electronic device 120 detected through the distance sensor is less than the preset distance threshold, which indicates that the user currently wears or holds the electronic device 120, the current state of the user is determined based on at least one of the motion information of the user or at least one of the heart rate data of the user. In this way, flexible and diverse ways are adopted to determine the current state of the user.

In some embodiments, the first module includes at least one of a display module, a touch module, a button module, and a motor module.

In some embodiments of the present disclosure, since the display module, the touch module, the button module, and the motor module generally need to be called by both the first operating system and the second operating system, at least one of the display module, touch module, button module, and motor module is set to be the first module, i.e., the common callable module, which allows the first operating system and the second operating system to call any one of the common callable modules and further facilitates to directly disabling the second operating system from calling the common callable module in a case where the second operating system is controlled or enabled to enter the target operating state. In this way, the second operating system may be controlled or enabled to enter the target operating state, so as to reduce the power consumption of the electronic device 120 while meeting the user needs.

In some embodiments, the second module 440 includes at least one of a WIFI module, a modem, a memory, a power management module, and an audio module.

The third module 460 is the module that may be called only by the first operating system. The third module 460 may include the GPS module, the A+G module, the PPG sensor, the barometer, the ECG, the light sensor, the BT module, etc., which is not limited herein. The first operating system may be configured to support the fundamental function of the electronic device 120, such as the time display function, the alarm scheduling function, the physiological data monitoring function, and the call notification function, etc., through the third module 460.

The second module 440 is the module that may be called only by the second operating system. The second module 440 may include the WIFI module, the modem, the memory, i.e., the EMMC, the PMIC, the audio module, etc., which is not limited herein. The second operating system may be configured support the complex function of the electronic device 120, such as the video and voice calling function, the gaming function, the multimedia playback function, etc., through the second module 440.

In some embodiments of the present disclosure, the second module 440 is the module that may be called by the second operating system. The second module 440 includes at least one of the WIFI module, the modem, the memory, the power management module, and the audio module. Therefore, the second operating system may be configured to support the complex function of the electronic device 120, such as the video and voice calling function, the gaming function, the multimedia playback function, etc., through the second module 440, thereby ensuring the user to normally use the complex function of the electronic device 120 in a case where the second operating system is in the first operating state.

In some embodiments, the first operating system is the RTOS and the second operating system is the Android system.

The RTOS refers to an operating system that is able to, when an external event or data is generated, receive and promptly process the external event or data. A processing result of the RTOS may further be configured to control the generating process or to provide a prompt response to a processing system within a specified duration, and to coordinate all real-time tasks to operate in synchronization. Therefore, a main feature of the RTOS is to provide the prompt response with a high reliability.

The Android system is generally referred to as Android. The Android is an open-source operating system based on a Linux kernel.

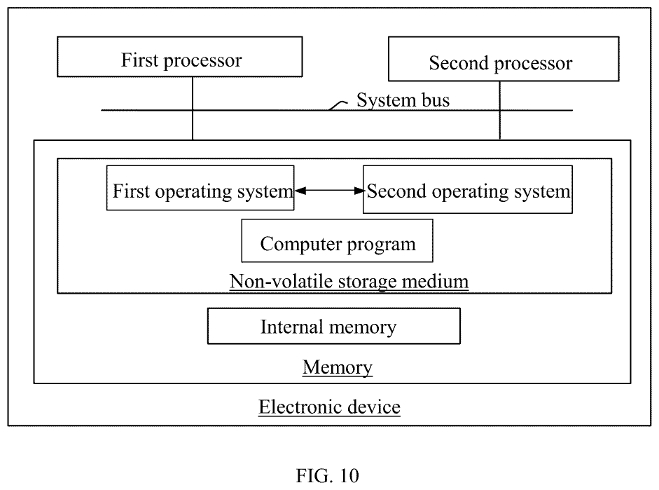

In some embodiments of the present disclosure, the electronic device 120 is capable of simultaneously running two systems, including the first operating system and the second operating system. The first operating system is the RTOS that is configured to support the fundamental function of the electronic device 120 and runs on a microcontroller unit (MCU). The second operating system is the Android system that is configured to support the complex function of the electronic device 120 and runs on a main CPU. As shown in the FIG. 10 below, a first processor and a second processor are the main CPU and the MCU, respectively.

In this way, in a case where both the first operating system and the second operating system are in at least one of the normal operating state and the high-power operating state, the current state of the user is detected. When the current state of the user meets the system-state switching condition, the second operating system is controlled or enabled to enter the standby state or the shutdown state. In this case, the second operating system temporarily does not support the complex function of the electronic device 120 and the fundamental function of the electronic device 120 is supported by the first operating system alone. Since the power consumption of the second operating system in the standby state or the shutdown state is lower than the power consumption of the second operating system in the normal operating state or the high-power operating state, the power consumption of the electronic device 120 may be reduced while the user is still ensured to use the fundamental function of the electronic device 120.

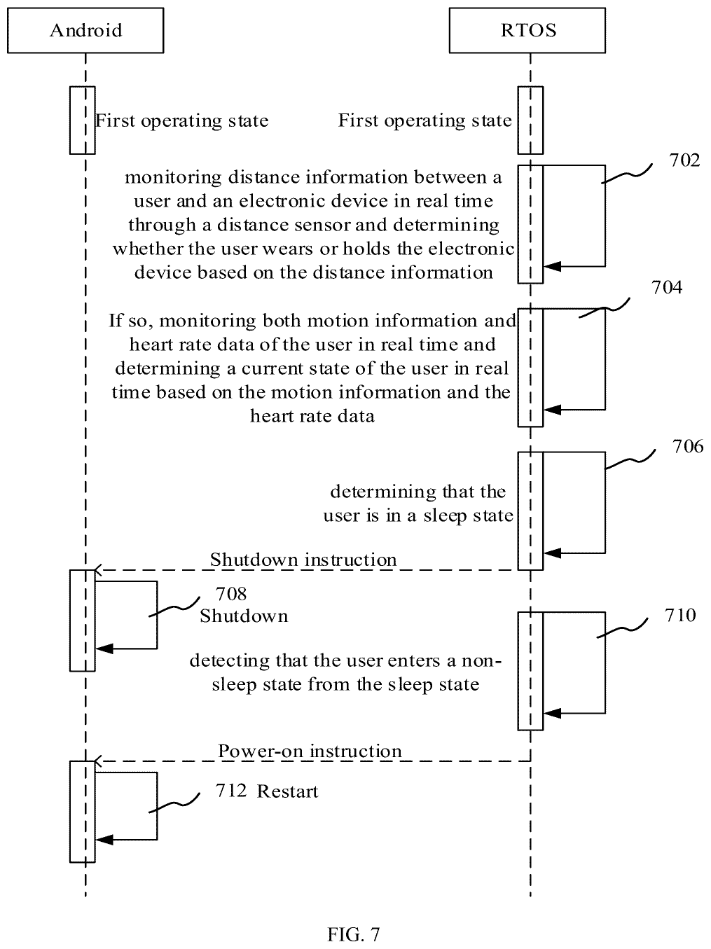

In some embodiments, a method for adjusting power consumption is provided. The method is performed by the electronic device 120. The electronic device 120 is capable of simultaneously running the RTOS and the Android system. When the electronic device 120 is powered on, both the RTOS and the Android system are in the first operating state. As shown in FIG. 7, the method for adjusting power consumption may include the following operations.

In an operation 702, a RTOS may monitor distance information between a user and an electronic device 120 in real time through a distance sensor and determine whether the user wears or holds the electronic device 120 based on the distance information. In a case where the user wears or holds the electronic device 120, the method proceeds to an operation 704.

In the operation 704, the RTOS may monitor motion information of the user in real time through an accelerometer sensor, monitor heart rate data in real time through an PPG sensor, and determine a current state of the user in real time based on the motion information and the heart rate data.

In an operation 706, the RTOS may send a notification message to an Android system, in a case where the RTOS determines that the user is in a sleep state, where the notification message carries a shutdown instruction.

In an operation 708, the Android system may be shut down, when the Android system receives the notification message.

In an operation 710, the RTOS may send another notification message to the Android system, in a case where the RTOS detects that the user enters a non-sleep state from the sleep state, where the another notification message carries a power-on instruction.

In an operation 712, the Android system may restart, when the Android system receiving the another notification message.

In some embodiments of the present disclosure, in a case where both the first operating system and the second operating system are in the first operating state, the current state of the user is detected in real time. In a case where the current state of the user is the sleep state, the second operating system is controlled or enabled to enter the target operating state. The current state of the user then continues to be detected. In a case where the current state of the user enters the non-sleep state from the sleep state, the second operating system is controlled to revert to the first operating state from the target operating state. That is to say, when the current state of the user changes, the second operating system may be switched to another operating state correspondingly. In this way, the second operating system is controlled or enabled to match with the current state of the user based on the current state of the user, thereby reducing the power consumption of the electronic device 120 while meeting the user needs.

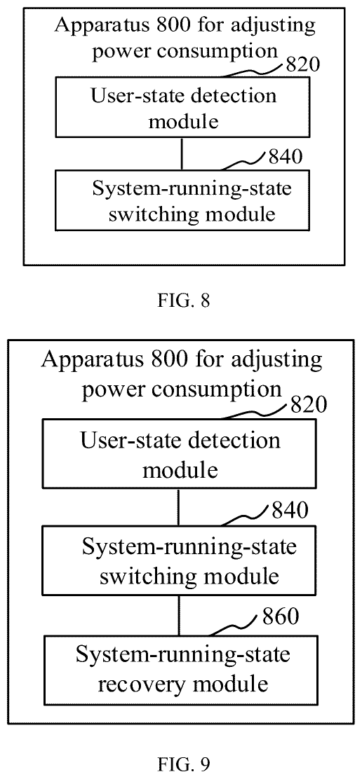

In some embodiments, as shown in FIG. 8, an apparatus 800 for adjusting power consumption is provided. The apparatus 800 is configured in the electronic device 120 that is capable of simultaneously running the first operating system and the second operating system. The apparatus may include the following modules.

A user-state detection module 820 may be configured to obtain the current state of the user, in a case where both the first operating system and the second operating system are in the first operating state.

A system-running-state switching module 840 may be configured to control the second operating system to enter the target operating state, in a case where the current state of the user meets the system-state switching condition. The power consumption of the second operating system in the target operating state is lower than the power consumption of the second operating system in the first operating state.

In some embodiments, the target operating state includes the standby state of the second operating system or the shutdown state of the second operating system.

In some embodiments, the system-running-state switching module 840 may be further configured to control or enable the second operating system to enter the target operating state, in a case where the current state of the user is the sleep state.

In some embodiments, the system-running-state switching module 840 may be further configured to transfer the control authority over the first module from the second operating system to the first operating system, and/or to control or enable the second module 440 operating under the second operating system to enter the target operating state. The first module is the common callable module shared by the first operating system and the second operating system.

In some embodiments, the system-running-state switching module 840 may be further configured to send the control-authority transfer instruction from the first operating system to the second operating system. The control-authority transfer instruction is configured to indicate the second operating system to transfer the control authority over the first module to the first operating system.

In some embodiments, the system-running-state switching module 840 may be further configured to send the control instruction from the first operating system to the second operating system. The control instruction is configured to control or enable the second module 440 operating under the second operating system to enter the target operating state.

In some embodiments, as shown in FIG. 9, an apparatus for adjusting power consumption is provided. The apparatus may further include the following module.

A system-running-state recovery module 860 may be configured to control the second operating system to revert to the first operating state from the target operating state, in a case where the current state of the user is the non-sleep state.

In some embodiments, the user-state detection module 820 may be configured to determine the current state of the user based on at least one of the motion information or at least one of the heart rate data in a case where the user wears or holds the electronic device 120.

In some embodiments, the first module includes at least one of the display module, the touch module, the button module, and the motor module.

In some embodiments, the second module 440 includes at least one of the WIFI module, the modem, the memory, the power management module, and the audio module.

In some embodiments, the first operating system is the RTOS and the second operating system is the Android system.

It should be understood that, although the various operations in the flowcharts of the above figures are shown sequentially according to the direction of the arrows, these operations are not necessarily executed in the order indicated by the arrows. Unless explicitly indicated herein, the execution of these operations is not strictly limited by sequence and these operations may be performed in other orders. Moreover, at least a part of the operations in the above figures may include multiple sub-operations or multiple stages, and these sub-operations or stages do not necessarily need to be completed at the same time, but may be performed at different times. The execution sequence of these sub-operations or stages is also not necessarily sequential, but can be performed alternately or in rotation with at least a part of other operations or sub-operations or stages of other operations.

The division of various modules in the apparatus for adjusting power consumption is for illustration purposes only. In other embodiments, the apparatus for adjusting power consumption may be divided into different modules as needed to complete all or part of the functions of the apparatus for adjusting power consumption above.

Details for the apparatus for adjusting power consumption can refer to the details for the method for adjusting power consumption described above, which will not be repeated herein. Each module in the apparatus for adjusting power consumption above may be implemented in whole or in part by a software, a hardware, or a combination thereof. Each of the above modules may be embedded in hardware form in a processor of a computer device or be independent of the processor of the computer device, or may be stored in software form in a memory of the computer device so that the processor may call and execute the operations corresponding to each module.

In some embodiments, an electronic device 120 is further provided. The electronic device 120 includes a memory and a processor. The memory stores a computer program, and when the computer program is executed by the processor, the processor is caused to perform the operations of the method for adjusting power consumption provided by the above embodiments.

FIG. 10 is a structural block diagram illustrating an internal structure of an electronic device 120 in some embodiments of the present disclosure. As shown in FIG. 10, the electronic device 120 includes a first processor, a second processor, and a memory. The first processor, the second processor, and the memory are connected via a system bus. The first processor and the second processor are configured to provide a computing capability and a control capability, so as to support an operation of the entire electronic device 120. The memory may include a non-volatile storage medium and an internal memory. The non-volatile storage medium stores the first operating system, the second operating system, and the computer program. The electronic device 120 may switch between the first operating system and the second operating system or may run both the first operating system and the second operating system simultaneously. The computer program may be executed by the first processor and the second processor to implement the method for adjusting the power consumption provided by the above embodiments. The internal memory is configured to provide a high-speed cache operating environment for the operating system computer program in the non-volatile storage medium. The electronic device 120 may be any terminal device, such as a mobile phone, a tablet, a PDA, a point of sale terminal (POS), an in-vehicle computer, a wearable device, a smart home, etc.

In some embodiments of the present disclosure, each module in the apparatus for adjusting power consumption may be executed in the form of a computer program. The computer program may run on the electronic device 120. A program module formed by the computer program may be stored in the electronic device 120 or in the memory of the electronic device 120. When the computer program is executed by the processor, the processor is caused to perform the operations of the method described in some embodiments of the present disclosure.

Some embodiments of the present disclosure further provide a computer-readable storage medium. The computer-readable storage medium may include at least one non-volatile computer-readable storage medium storing a computer-executable instruction. When the computer-executable instruction is executed by at least one processor, the at least one processor is caused to perform the operations of the method for adjusting power consumption.

Some embodiments of the present disclosure further provide a computer program product that includes an instruction. When the computer program product is executed on a computer, the computer is caused to perform the method for adjusting power consumption.

Any reference to a memory, a storage, a database, or any other medium in some embodiments of the present disclosure may include at least one of a non-volatile and at least one of a volatile storage medium. The suitable non-volatile storage medium may include a read-only memory (ROM), a programmable ROM (PROM), an electrically programmable ROM (EPROM), an electrically erasable programmable ROM (EEPROM), or a flash memory. The volatile storage medium may include a random access memory (RAM) that serves as an external high-speed buffer memory. As an illustration and not a limitation, the RAM is available in various forms, such as a static RAM (SRAM), a dynamic RAM (DRAM), a synchronous DRAM (SDRAM), a double data rate SDRAM (DDR SDRAM), an enhanced SDRAM (ESDRAM), a Synchlink DRAM (SLDRAM), a Rambus direct RAM (RDRAM), a direct Rambus dynamic RAM (DRDRAM), and a Rambus dynamic RAM (RDRAM).

The above embodiments for adjusting power consumption only represent a few embodiments of the present disclosure. They are described in a specific and detailed manner but should not be understood as limiting the scope of the present disclosure. It should be noted that for those skilled in the art, without departing from the ideas of the present disclosure, several variations and improvements may be made, all of which fall within the scope of the present disclosure. Therefore, the scope of the present disclosure shall be defined by the appended claims.

1. A method for adjusting power consumption, performed by an electronic device, the electronic device being capable of simultaneously running a first operating system and a second operating system, and the method comprising:
obtaining a current state of a user; and
controlling the second operating system to enter a target operating state, in a case where the current state of the user meets a system-state switching condition, wherein power consumption of the second operating system in the target operating state is lower than power consumption of the second operating system in a first operating state.

2. The method as claimed in claim 1, wherein the target operating state comprises a standby state of the second operating system or a shutdown state of the second operating system.

3. The method as claimed in claim 2, wherein the controlling the second operating system to enter a target operating state, comprises:
controlling the second operating system to enter the target operating state, in a case where the current state of the user is a sleep state or a do-not-disturb state.

4. The method as claimed in claim 3, wherein the controlling the second operating system to enter the target operating state, comprises at least one of the following operations:
transferring a control authority over a first module from the second operating system to the first operating system, wherein the first module is a common callable module shared by the first operating system and the second operating system; or
controlling a second module operating under the second operating system to enter the target operating state.

5. The method as claimed in claim 4, wherein the transferring a control authority over a first module from the second operating system to the first operating system, comprises:
sending a control-authority transfer instruction from the first operating system to the second operating system, wherein the control-authority transfer instruction is configured to indicate the second operating system to transfer the control authority over the first module to the first operating system.

6. The method as claimed in claim 4, wherein the controlling a second module operating under the second operating system to enter the target operating state, comprises:
sending a control instruction from the first operating system to the second operating system, wherein the control instruction is configured to control the second module operating under the second operating system to enter the target operating state.

7. The method as claimed in claim 3, further comprising:
controlling the second operating system to revert to the first operating state from the target operating state, in a case where the current state of the user is a non-sleep state.

8. The method as claimed in claim 1, wherein the obtaining a current state of a user, comprises:
determining the current state of the user based on at least one of motion information or at least one of heart rate data, in a case where the user wears or holds the electronic device.

9. The method as claimed in claim 4, wherein the first module comprises at least one of a display module, a touch module, a button module, and a motor module.

10. The method as claimed in claim 6, wherein the second module comprises at least one of a WIFI module, a modem, a memory, a power management module, and an audio module.

11. The method as claimed in claim 1, wherein the first operating system is a real-time operating system (RTOS) and the second operating system is an Android system.

12. (canceled)

13. An electronic device, comprising a memory and a processor and being capable of simultaneously running a first operating system and a second operating system, wherein the memory stores a computer program which, when executed by the processor, causes the processor to perform a method for adjusting power consumption, and the method comprising:
obtaining a current state of a user; and
controlling the second operating system to enter a target operating state, in a case where the current state of the user meets a system-state switching condition, wherein power consumption of the second operating system in the target operating state is lower than power consumption of the second operating system in a first operating state.

14. A non-transitory computer-readable storage medium storing a computer program which, when executed by a processor, cause the processor to perform a method for adjusting power consumption; wherein the method is performed by an electronic device, the electronic device is capable of simultaneously running a first operating system and a second operating system, and the method comprises:
obtaining a current state of a user; and
controlling the second operating system to enter a target operating state, in a case where the current state of the user meets a system-state switching condition, wherein power consumption of the second operating system in the target operating state is lower than power consumption of the second operating system in a first operating state.

15. The method as claimed in claim 1, wherein power consumption of the electronic device running the first operating system is lower than power consumption of the electronic device running the second operating system.

16. The method as claimed in claim 1, wherein the obtaining a current state of a user is performed in a case where both the first operating system and the second operating system are in the first operating state.

17. The electronic device as claimed in claim 13, wherein the processor comprises a first processor and a second processor, the first processor is configured to run the second operating system, and the second processor is configured to run the first operating system.

18. The electronic device as claimed in claim 13, wherein the target operating state comprises a standby state of the second operating system or a shutdown state of the second operating system; and
wherein the controlling the second operating system to enter a target operating state, comprises:
controlling the second operating system to enter the target operating state, in a case where the current state of the user is a sleep state or a do-not-disturb state.

19. The electronic device as claimed in claim 18, wherein the method further comprises:
controlling the second operating system to revert to the first operating state from the target operating state, in a case where the current state of the user is a non-sleep state.

20. The non-transitory computer-readable storage medium as claimed in claim 14, wherein the target operating state comprises a standby state of the second operating system or a shutdown state of the second operating system; and
wherein the controlling the second operating system to enter a target operating state, comprises:
controlling the second operating system to enter the target operating state, in a case where the current state of the user is a sleep state or a do-not-disturb state.

21. The non-transitory computer-readable storage medium as claimed in claim 20, wherein the method further comprises:
controlling the second operating system to revert to the first operating state from the target operating state, in a case where the current state of the user is a non-sleep state.
